(19) United States
(12) Patent Application Publication
(10) Pub. No.: US 2005/0067087 A1
(43) Pub. Date: Mar. 31, 2005

(54) Manufacturing method of prism having multilayer film on its surface

(75) Inventor: Takashi Sannokyou, Osaka (JP)

Correspondence Address: BRINKS HOFER GILSON & LIONE, P.O. BOX 10395, CHICAGO, IL, 60610, US

(73) Assignee: Konica Minolta Opto, Inc.

(21) Appl. No.: 10/945,621

(22) Filed: Sep. 21, 2004

(30) Foreign Application Priority Data
Sep. 29, 2003 (JP) 2003-336647 PAT.

(51) Int. Cl. B32B 31/00

(52) U.S. Cl. 156/99; 359/900; 156/250

(57) ABSTRACT

Disclosed herein is a manufacturing method of a prism having a first surface provided with a first multilayer film thereon; a second surface provided with a second multilayer film thereon; and third surface provided with a polarizing beam splitting film for transmitting a P-polarized component of light with wavelength of 420 nm or less and reflecting an S-polarized component. The polarizing beam splitting film is provided onto the third surface after the first and second multilayer films are provided onto the first and second surfaces, respectively.

This application is based on the application No. 2003-336647 filed in Japan Sep. 29, 2003, the entire content of which is hereby incorporated by reference.

### BACKGROUND OF THE INVENTION

1. Field of the Invention

The present invention relates to a manufacturing method of a prism, and specifically relates to a manufacturing method of a prism where a multilayer film is deposited on its surface. Concretely, the invention relates to a manufacturing method of a prism having a polarization beam splitting film (a PBS film) which selectively transmits a P-polarized component and selectively reflects an S-polarized component on its surface, and particularly relates to a manufacturing method of a prism having a PBS film for light with a wavelength of 420 nm or less.

2. Description of the Related Art

In optical pickups which carry out input and output into/from optical recording media such as compact discs (CD) and digital video discs (DVD), prisms provided with multilayer films are used for selectively transmitting and reflecting light. The multilayer films provided to prisms include reflecting films for reflecting entire light, anti-reflection films for transmitting entire light, PBS films for transmitting a P-polarized component and reflecting an S-polarized component, and the like. Further, some multilayer films are provided into prisms, and other multilayer films are provided onto surfaces of prisms.

The multilayer films provided into prisms are used for branching and bending an optical path, and are generally provided so as to tilt with respect to the surfaces. The multilayer films provided onto the surfaces of prisms which are used for branching an optical path are provided onto the surfaces which tilt with respect to the other surfaces.

Japanese Patent Application Laid-Open No. 7-43508 (1995) discloses a method of efficiently manufacturing a prism having two multilayer films which are parallel with each other and tilt with respect to the surface in its inside, and a prism which has a multilayer film on its surface which tilts with respect to the other surfaces and is parallel with its surface in its inside. A prism which is manufactured by this method is shown in FIG. 4, and its manufacturing method is shown in FIG. 5.

A prism 50 in FIG. 4 is constituted so that a first section 50a whose section is parallelogram and a second section 50b whose section is rectangular are joined. A first multilayer film 51 is provided onto a surface of the first section 50a which is far from the second section 50b. A second multilayer film 52 is provided onto a joined surface between the first section 50a and the second section 50b which is parallel with the surface provided with the first multilayer film 51.

The prism 50 is manufactured in the following manner. First, as shown in FIG. 5A, flat plates 53 where the multilayer film 51 is provided onto one of the opposed surfaces the multilayer film 52 is provided onto the other surface, and flat plates 54 where nothing is provided on their surface are joined alternatively so as to form a block. This block is cut along surfaces E which tilt with respect to the joined surfaces so as to obtain flat plates, and both surfaces of the obtained flat plates are polished. As shown in FIG. 5B, the flat plate has the multilayer films 51 and 52 which tilt with respect to the surfaces therein.

The flat plates 55 are cut along surfaces F which are vertical to the surfaces, so that bars whose section is rectangular are obtained. At the time of cutting, one bar includes the multilayer film 51 and the multilayer film 52. The bar is divided into a parallelogram portion on its center and rectangular portions which adjoin the parallelogram portion, so that a bar whose section is trapezoidal is obtained. Further, the trapezoidal bar is cut along surfaces G which vertical to the parallel surfaces and the multilayer films 51 and 52, so that the prism 50 is obtained. If the bar is not divided into the parallelogram portion and the rectangular portions, a prism which has the parallel multilayer films 51 and 52 therein and whose section is rectangular is obtained.

In this method, the surfaces of the prisms 50 which are parallel with each other can be polish together in the bar form. It is not necessary that the multilayer films 51 and 52 are individually provided to the prisms 50. For this reason, this method is advantageous to manufacturing efficiency. Most of the prisms which has the multilayer films on the surfaces which tilt with respect to the other surfaces are, therefore, manufactured by this method even if they do not have the multilayer films therein.

Wavelength of light to be used for input and output into/from CDs and DVDs is about 650 nm or more. In recent years, optical recording media with higher recording density are being developed. The wavelength of light to be used for input and output is about 400 nm which is short.

The multilayer film is constituted so that films with high reflective index and films with low reflective index are laminated alternatively. As to a reflecting film and an anti-reflection film, when the number of films to be laminated is about 20, satisfactory characteristics where reflectance and transmittance for light with any wavelength are approximately 100% can be obtained. As to a PBS film to be used for light with long wavelength of about 600 nm or more, when the number of films to be laminated is about 20, the PBS film can satisfactorily split light into a P-polarized component and an S-polarized component.

As to a PBS film which is provided onto an interface with an air and is used for light with short wavelength of about 400 nm or less, if the number of the films to be laminated is not about 50 or more, a part of the S-polarized component to be reflected is transmitted, and light cannot be sufficiently split into a P-polarized component and an S-polarized component. A thickness of the PBS film composed of a lot of films approaches approximately 4 μm.

When after the PBS film with such a thickness is formed, another multilayer film is formed, the PBS film expands or contracts due to heating and cooling to a room temperature at the time of forming the films. As a result, the characteristics of the film are deteriorated, and in the case of marked deterioration, crack and split occur. In the case where the PBS film is provided onto the tilted surface of the prism (in the case where the PBS film contacts with air), the method of Japanese Patent Application Laid-Open No. 7-43508 (1995) is efficient. In this method, however, since a PBS film is first formed, if the PBS film is used for light with short wavelength of about 400 nm or less, it is easily deteriorated.

### SUMMARY OF THE INVENTION

The objective of the present invention is to provide a prism manufacturing method which solves the above problem. Another objective of the present invention is to provide a manufacturing method of a prism where a multilayer film is deposited on its plural surfaces and one of the multilayer films is a PBS film for light of about 400 nm or less without deteriorating characteristics of the PBS film.

In order to achieve the above objects, the present invention is a manufacturing method of a prism having a first surface, a second surface and a third surface, and having a multilayer film on the surfaces, wherein after the multilayer films are provided onto the first surface and the second surface, respectively, the PBS film for transmitting a P-polarized component of light in wavelength region of 420 nm or less and reflecting an S-polarized component is provided onto the third surface.

In the case where a multilayer film is provided onto another surfaces, it is desirable that the PBS film is formed on the third surface in the last place.

### BRIEF DESCRIPTION OF THE DRAWINGS

These and other objects, advantages and features of the invention will become apparent from the following description thereof taken in conjunction with the preferred embodiments with the reference to the accompanying drawings in which:

FIG. 1 is a sectional view schematically illustrating a constitution of a prism to be manufactured by a method according to one embodiment of the present invention;

FIG. 2 is a diagram schematically illustrating an optical constitution of an optical pickup;

FIGS. 3A, 3B, 3C and 3D are sectional views schematically illustrating some of the prism manufacturing steps according to one embodiment of the present invention;

FIG. 4 is a sectional view schematically illustrating a constitution of the prism to be manufactured by a conventional method; and

FIGS. 5A and 5B are sectional views schematically illustrating some of the prism manufacturing steps shown in FIG. 4.

### DETAILED DESCRIPTION OF THE PREFERRED EMBODIMENT

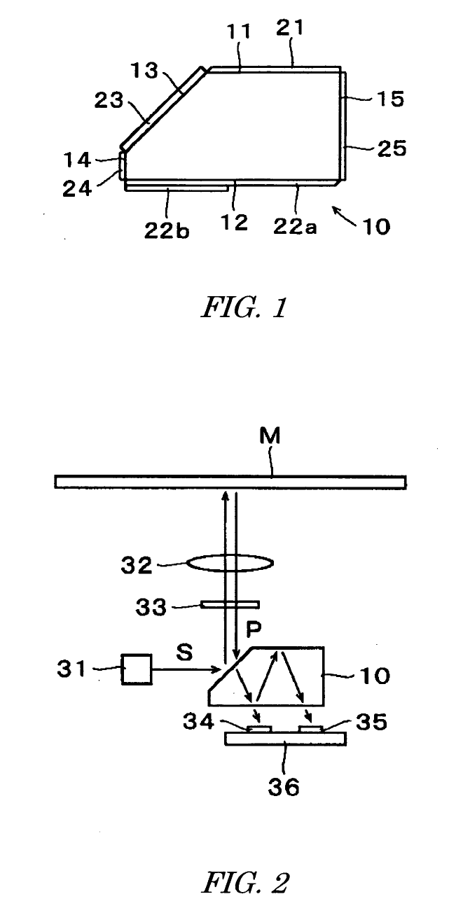

An embodiment of the present invention is explained below with reference to the drawings. FIG. 1 illustrates a prism 10 to be manufactured in the embodiment. The prism 10 has a first surface 11, a second surface 12, a third surface 13, a fourth surface 14 and a fifth surface 15 which are vertical to a sheet surface of FIG. 1, and two surfaces which are parallel with the sheet surface (not shown).

The first surface 11 and the second surface 12 are parallel with each other. The third surface 13 forms an angle of 45° with respect to the first surface 11 and the second surface 12, and intersects with the first surface 11. The fourth surface 14 is vertical to the first surface 11 and the second surface 12, and intersects with the second surface 12 and the third surface 13. The fifth surface 15 is vertical to the first surface 11 and the second surface 12, and intersects with the first surface 11 and the second surface 12. The second surface 12 is, therefore, opposed to the first surface 11 and the third surface 13.

The first to the fifth surfaces 11 to 15 are provided with multilayer films, respectively. These multilayer films are designed for light with a wavelength of 420 nm or less.

A multilayer film 21 provided onto the first surface 11 is a reflecting film for reflecting light entirely. The second surface 12 has a multilayer film 22a provided on its entire surface and a multilayer film 22b provided onto the multilayer film 22a. The multilayer film 22a is an anti-reflection film for reducing a reflection light, and the multilayer film 22b is a semi-transparent (half-mirror) film for transmitting and reflecting light with a predetermined ratio. Transmittance of the multilayer film 22b is set to about 50%. The multilayer film 22b is provided to a portion which is an entire area opposed to the third surface 13 and includes a part of an area opposed to the first surface 11 on the second surface 12.

A multilayer film 23 provided onto the third surface 13 is a PBS film which transmits a P-polarized component entirely and reflects an S-polarized component entirely so as to split both the polarized components. Since the wavelength of light to be split into polarized components is 420 nm or less, namely, short, the multilayer film 23 is formed by laminating 50 or more films with high refractive index and with low refractive index. A multilayer film 24 provided onto the fourth surface 14 is a reflecting film, and a multilayer film 25 provided onto the fifth surface 15 is an anti-reflection film.

The prism 10 having the above constitution can be used for an optical pickup for executing input/output into/from an optical recording medium using light with wavelength of about 400 nm. FIG. 2 illustrates an optical constitution of such an optical pickup.

The optical pickup has a prism 10, a laser diode 31, an objective lens 32, a ¼ wavelength phase plate 33, and two photodiodes 34 and 35. The laser diode 31 is arranged so that a principal ray of a laser beam to be emitted and the third surface 13 of the prism 10 form an angle of 45° and a laser beam to be emitted becomes S-polarized light with respect to the third surface 13. The wavelength of the laser beam to be emitted from the laser diode 31 is 407 nm±10 nm.

The objective lens 32 is arranged so that its optical axis passes through an intersection point of the principal ray of the laser beam emitted from the laser diode 31 and the third surface 13, and the optical axis and the third surface 13 form an angle of 45°. The objective lens 32 converges the laser beam from the laser diode 31 reflected by the third surface 13 onto a recording layer of an optical recording medium M.

The ¼ wavelength phase plate 33 is arranged between the third surface 13 and the objective lens 32 so as to intersect perpendicularly to the optical axis of the objective lens 32. The two photodiodes 34 and 35 are arranged on one substrate 36 so as to be parallel with the second surface 12. The photodiode 34 is opposed to a portion provided with the multilayer film 22b on the second surface 12, and the other photodiode 35 is opposed to a portion which is not provided with the multilayer film 22b on the second surface 12. The photodiodes 34 and 35 have a plurality of areas for independently detecting light so that information recorded on the recording medium M is detected based on a difference in the amount of light received between the areas.

The light emitted from the laser diode 31 enters the PBS film 23 of the third surface 13, and since this is linearly polarized light of the S-polarized light with respect to the PBS film 23, the entire light is reflected. The light reflected by the PBS film 23 transmits through the ¼ wavelength phase plate 33 so as to become circularly polarized light. The circularly polarized light transmits through the objective lens 32, and is converged onto the recording layer of the recording medium M so as to be reflected.

The light reflected by the recording medium M transmits through the objective lens 32, and further transmits through the ¼ wavelength phase plate 33 so as to be linearly polarized light. Since the linearly polarized light becomes P-polarized light with respect to the PBS film 23 of the third surface 13, it entirely transmits through the PBS film 23 and the third surface 13 so as to enter the prism 10.

When the P-polarized light enters the prism, refraction occurs, and thus the light which enters the prism 10 tilts with respect to the second surface 12. The light enters the portion provided with the semi-transparent film 22b on the second surface 12. The light which enters the second surface 12 transmits therethrough, and further transmits through the anti-reflection film 22a so as to enter the semi-transparent film 22b. A half of the light which enters the semi-transparent film 22b transmits therethrough, so as to reach the photodiode 34. The other half of the light is reflected by the semi-transparent film 22b, and are again transmitted through the anti-reflection film 22a and the second surface 12 so as to enter the first surface 11.

The light which enters the first surface 11 is reflected by the reflecting film 21, and enters a portion on the second surface 12 which is not provided with the semi-transparent film 22b, namely, a portion which is provided with only the anti-reflection film 22a. This light transmits through the second surface 12 and through the anti-reflection film 22a entirely so as to reach the photodiode 35.

Output signals from the photodiodes 34 and 35 are given to a signal processing circuit, not shown. The signal processing circuit detects a signal which is held by the light from the recording medium M, namely, information recorded on the recording medium M based on the output signals form the photodiodes 34 and 35.

The reflecting film 24 is provided onto the fourth surface 14 because faint light on a periphery of the divergent light emitted from the laser diode 31 is prevented from entering the prism 10 and the photodiodes 34 and 35. Further, the anti-reflection film 25 is provided onto the fifth surface 15 because when scattering occurs at the time of reflection by means of the recording medium M, the scattered light is prevented from entering the prism 10 at an angle different from that of original light, being reflected by the semi-transparent film 22b and the reflecting film 21, further being reflected by the fifth surface 15, and entering areas of the photodiodes 34 and 35 which should not be entered.

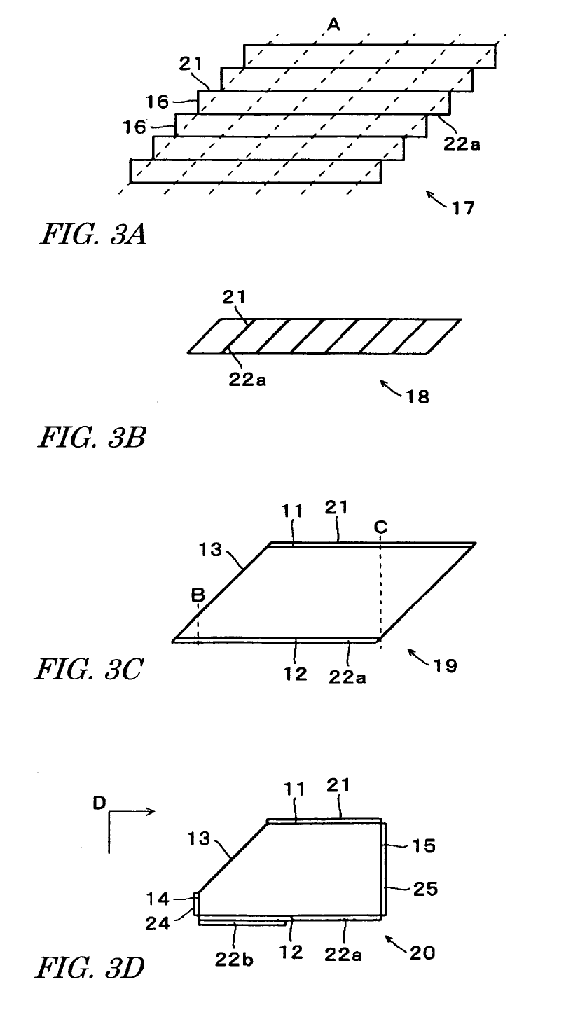

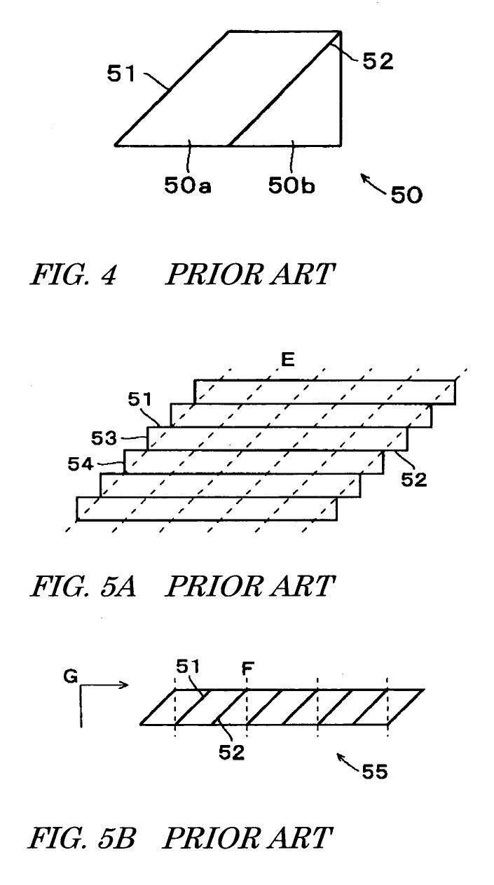

The method of manufacturing the prism 10 is explained. FIGS. 3A to 3D illustrate some of the steps of manufacturing the prism 10. A plurality of parallel flat plates 16 which has two opposed and smooth surfaces and are transparent for light with wavelength of 420 nm or less are prepared. The reflecting film 21 is formed on one surface of each of the flat plates 16, and the anti-reflection film 22a is formed on the other surface. As shown in FIG. 3A, the flat plates 16 are joined with an adhesive in a state that the reflecting films 21 face the anti-reflection films 22a and the flat plates 16 displace to one direction by a thickness of the flat plate 16, so as to form a block 17. Since the joined flat plates 16 are divided later, the adhesive which enables the division, for example, the adhesive which dissolves in a predetermined solvent is used.

The block 17 is cut along surfaces A which tilt at 45° with respect to the joined surfaces of the flat plates 16, and as shown in FIG. 3B, a plurality of flat plates 18 are formed. The flat plates 18 contain the reflecting film 21 and the anti-reflection film 22a which form an angle of 45° with respect to front surfaces (cutting surfaces).

Thereafter, the flat plates 18 are divided along the joined surfaces, and as shown in FIG. 3C, a plurality of bar-shaped prism members (hereinafter referred to as bars) 19 whose sections are parallelogram are formed. The bars 19 have the reflecting film 21 and the anti-reflection film 22a on the two opposed surfaces, respectively, and the surfaces having them become the first surface 11 and the second surface 12 of the prism 10, respectively. Further, one of the other two surfaces becomes the third surface 13.

The surface of the bar 19 as the third surface 13 and the surface opposed to this are polished. A double-faced lapping machine is used for the polishing so as to process the plural bars 19 simultaneously. It is not necessary that the surface which is not the third surface 13 is polished, but in order to process the plural bars 19 simultaneously so as to heighten the efficiency, the double-faced lapping machine is preferably used. In addition, the polishing may be performed before the flat plates 18 are divided into the bars 19.

After the surfaces are polished, the bars are cut along surfaces B which are vertical to the surfaces having the reflecting film 21 and the surfaces having the anti-reflection film 22a and intersect with the third surfaces 13. In such a manner, surfaces to be the fourth surfaces 14 are exposed. Further, the bars are cut along surfaces C which are vertical to the surfaces having the reflecting film 21 and the surfaces having the anti-reflection film 22a and intersect with these surfaces, so that surfaces to be the fifth surfaces 15 are exposed. The cutting along the surfaces B may be carried out first, or the cutting along the surfaces C may be carried out first. All the bars 19 are cut along the surfaces B and the surfaces C at the same time in a state that the ends of the bars 19 are aligned. Each two surfaces which are exposed after the bars 19 are cut along the surfaces B and C are polished.

As shown in FIG. 3D, the semi-transparent film 22b is formed on the anti-reflection film 22a, the reflecting film 24 is formed on the surface to be the fourth surface 14, and the anti-reflection 25 is formed on the surface to be the fifth surface 15. These multilayer films 22b, 24 and 25 may be formed in an arbitrary order.

After the multilayer films 22b, 24 and 25 are formed, the PBS film 23 is formed on the surface to be the third surface 13. That is to say, the PBS film 23 of all the multilayer films 21, 22a, 22b, 23, 24 and 25 in the prism 10 is formed in the last place. The bars 19 are finally cut along surfaces D which are vertical to the surfaces to be the first surface 11, the second surface 12 and the third surface 13, so as to be divided into individual prisms. In such a manner, the prism 10 is obtained.

As to the PBS film 23 for separating the polarized light with short wavelength of 420 nm or less, since the number of films to be laminated is large, its thickness is large. Since the PBS film 23 is, however, formed after the other multilayer films 21, 22a, 22b, 24 and 25 are formed, the PBS film 23 is not influenced by heat at the time of forming the other multilayer films and has satisfactory characteristics. Further, crack and split do not occur on the PBS film 23.

According to the embodiment, the prism which has the multilayer films on its parallel surfaces and the PBS film for light with short wavelength on its surface tilting with respect to the parallel surfaces can be provided without deteriorating the characteristics of the PBS film. When the obtained prism is adopted to optical pickups, when information recorded with high density is reproduced, reliability is improved.

The embodiment explains the example of the prism having only one PBS film, but in the case of a prism having a plurality of the PBS films, it is preferable that after the multilayer films other than the PBS films are formed, the PBS films are formed. Further, the present invention can be applied to even prisms having shapes different from the shape of the prism 10 as long as those prisms have the multilayer films on their plural surfaces and the PBS film on their surface tilting with respect to the surfaces.

Although the present invention has been described and illustrated in detail, it is clearly understood that the same is by way of illustration and example only and is not to be taken by way of limitation, the spirit and scope of the present invention being limited only by the terms of the appended claims.

1. A manufacturing method of a prism having a first surface, a second surface, and a third surface, comprising the steps of:
forming a first multilayer film on the first surface;
forming a second multilayer film on the second surface; and
forming a polarizing beam splitting film for transmitting a P-polarized component of light with wavelength of 420 nm or less and reflecting an S-polarized component of the light on the third surface after the steps of forming the first and second multilayer films.

2. A manufacturing method as claimed in claim 1, wherein the second surface is approximately parallel with the first surface, and the third surface tilts with respect to the first surface and the second surface.

3. A manufacturing method as claimed in claim 1, wherein the first multilayer film is a reflecting film for totally reflecting light.

4. A manufacturing method as claimed in claim 1, wherein the second multilayer film is an anti-reflection film.

5. A manufacturing method of a prism having multilayer filmes on surfaces thereof, comprising the steps of:
preparing a plurality of parallel glass plates, each parallel glass plate having a first surface and a second surface parallel to the first surface;
forming a first multilayer film on the first surface and a second multilayer film on the second surface;
joining the plurality of parallel glass plates with an adhesive such that the first multilayer films face the second multilayer films, so as to form a first block;
cutting the first block at 45 degrees with respect to a joined surfaces of the parallel glass plates so as to form a flat plate block;
dividing the joined surfaces of the flat plate block so as to form a plurality of bar-shaped prism members;
polishing a cutting surface of the flat plate block at the step of cutting the first block so as to form third surfaces of the prism;
forming a polarization beam splitting film for transmitting a P-polarized component of light with wavelength of 420 nm or less and reflecting an S-polarized component of the light on the third surface; and
cutting the bar-shaped prism member along a surface vertical to the first, the second and the third surfaces.

6. A manufacturing method as claimed in claim 5, further comprising the step of cutting the bar-shaped prism member along a fourth surface that is vertical to the first and second surfaces and intersects with the second surface before the step of forming the polarization beam splitting film on the third surface.

7. A manufacturing method as claimed in claim 5, further comprising the step of cutting the bar-shaped prism member along a fifth surface that is vertical to the first and second surfaces and intersects with the first and second surfaces before the step of forming the polarization beam splitting film on the third surface.

8. A manufacturing method as claimed in claim 6, further comprising the step of polishing the fourth surface.

9. A manufacturing method as claimed in claim 7, further comprising the step of polishing the fifth surface.

10. A manufacturing method as claimed in claim 8 further comprising the step of forming a fourth multilayer film on the fourth surface.

11. A manufacturing method as claimed in claim 9, further comprising the step of forming a fifth multilayer film on the fifth surface.

12. A manufacturing method as claimed in claim 5, wherein the first multilayer film is a reflecting film for totally reflecting light.

13. A manufacturing method as claimed in claim 5, wherein the second multilayer film is an anti-reflection film.

14. A manufacturing method as claimed in claim 5, wherein the fourth multilayer film is a reflecting film for totally reflecting light.

15. A manufacturing method as claimed in claim 5, further comprising the step of forming a sixth multilayer film on the second multilayer film before the step of forming the polarization beam splitting film on the third surface, the sixth multilayer film being provided to a portion which is an entire area opposed to the third surface and includes a part of an area opposed to the first surface, on the second multilayer film, and the sixth multilayer film being a semi-transparent film for transmitting and reflecting light with a predetermined ratio.

16. A manufacturing method as claimed in claim 15, wherein a transmittance of the sixth multilayer film is set to about 50%.

17. A manufacturing method as claimed in claim 5, wherein the adhesive used at the step of joining the plurality of parallel glass plates dissolves in a predetermined solvent.
